(19) United States
(12) Patent Application Publication
(10) Pub. No.: US 2010/0172318 A1
(43) Pub. Date: Jul. 8, 2010

(54) Handling Hybrid Automatic Repeat Requests in Wireless Systems

(75) Inventors: Yuan Zhu, Beijing (CN); Qinghua Li, San Ramon, CA (US); Changlong Xu, Beijing (CN); Hongmei Sun, Beijing (CN); Hujun Yin, Saratoga, CA (US)

Correspondence Address: TROP, PRUNER & HU, P.C., 1616 S. VOSS RD., SUITE 750, HOUSTON, TX, 77057-2631, US

(73) Assignee: Intel Corporation

(21) Appl. No.: 12/639,078

(22) Filed: Dec. 16, 2009

Related U.S. Application Data
(60) Provisional application No. 61/142,582, filed on Jan. 5, 2009.

(51) Int. Cl. H04W 72/00; H04B 1/00

(52) U.S. Cl. 370/330; 375/132

(57) ABSTRACT

A mobile station may implement an uplink hybrid automatic repeat request acknowledgement channel. The mobile station may use frequency hopping to randomize inter cell interference. The mobile unit may use time division multiplexing, frequency division multiplexing, and/or code division multiplexing.

### CROSS-REFERENCE TO RELATED APPLICATIONS

This application claims priority to provisional application 61/142,582, filed Jan. 5, 2009, hereby expressly incorporated by reference herein.

### BACKGROUND

This relates generally to wireless communications and, particularly, to the use of hybrid automatic repeat requests (HARQ) in wireless systems.

In order to reduce errors in communications between base stations and mobile stations in wireless networks, the mobile station sends a response to signals it receives to indicate whether or not there were errors in the received signal. The communication channel from the base station to the mobile station, called the downlink, may include hybrid automatic repeat request (HARQ) packets. The channel from the mobile station to the base station, called the uplink, provides either an acknowledgement (ACK) or a negative acknowledgement (NAK) if errors were contained in the transmission.

Basically, in HARQ, error detection information bits are added to the data to be transmitted. Based on these bits, the mobile station can determine whether it received the information transmitted from the base station correctly. It sends an acknowledgement if it did receive them correctly and a negative acknowledgement if it did not.

A HARQ region is designed using three distributed feedback mini-tile (FMT), each having two sub-carriers by six Orthogonal Frequency Division Multiplexing (OFDM) symbols. A code division multiplexed based method has been proposed, but it has been found that a pure code division multiplexed based approach may have error floors for high mobility scenarios, especially with parallel multi-user transmissions. A time division multiplexed/frequency division multiplexed based method has also been proposed. In time division multiplexed/frequency division multiplexed designs, one HARQ feedback region is split into six orthogonal HARQ feedback channels using time division or frequency division multiplexing. Each HARQ feedback channel includes three units having one sub-carrier by two OFDM symbols. An orthogonal sequence of length two may be used to convey the one bit acknowledge negative acknowledge information. The time division/frequency division multiplexing design can overcome the error floor in high mobility scenarios. Moreover, the performance is robust to mobile station moving speed.

A hybrid time division, frequency division, code division multiplexing method can achieve similar performance and also is robust to high mobility. However, the major drawback to time division/frequency division multiplexed designs is that the distributed transmission power in the original design concentrates on three tiles and, thus, may cause interference to other cells.

### BRIEF DESCRIPTION OF THE DRAWINGS

FIG. 1 is a schematic depiction of one embodiment;

FIG. 2 is a time division/frequency division design of an HARQ feedback channel in accordance with one embodiment;

FIG. 3 is a time division/frequency division multiplexed design of an HARQ feedback channel in accordance with another embodiment;

FIG. 4 is a time division/frequency division/code division multiplexing design of an HARQ feedback channel in accordance with still another embodiment;

FIG. 5 is a flow chart for interference randomization in accordance with one embodiment;

FIG. 6 is an HARQ channel sub-carrier indexing scheme in accordance with one embodiment; and

FIG. 7 is a depiction of an exemplary 19 cell network with each cell having three sectors, α, β, and λ.

### DETAILED DESCRIPTION

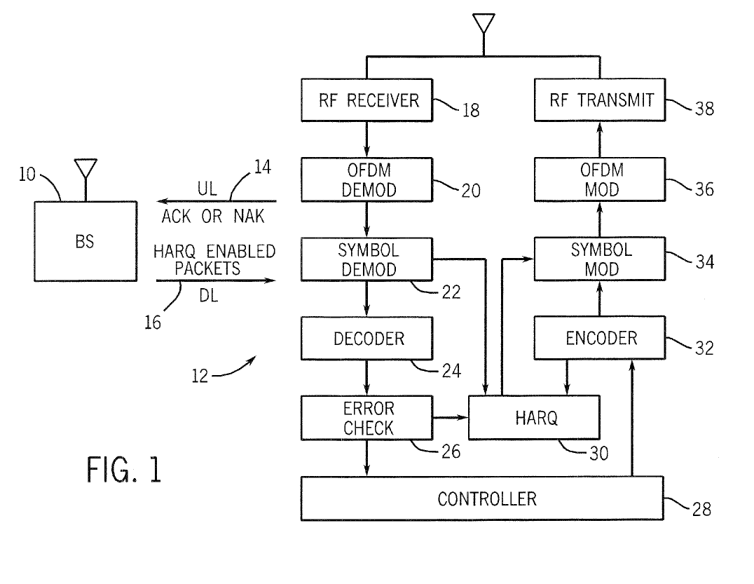

Referring to FIG. 1, a base station 10 may provide HARQ enabled packets over a downlink channel 16 to a mobile station 12. The mobile station 12 may provide an uplink acknowledge channel 14, which provides either an acknowledge (ACK) or a negative acknowledge (NAK).

The mobile station 12 may include a radio frequency receiver 18, coupled to an OFDM demodulator 20. The OFDM demodulator may be coupled to a symbol demodulator 22, which may handle sub-carrier de-mapping. The symbol demodulator 22 may be coupled to an HARQ buffer 30. It may also be coupled to a decoder 24. An error check 26 determines whether there is an error in the HARQ enabled packets received on the downlink channel 16 and communicates with the HARQ buffer 30 to so indicate, as well as the controller 28.

On the transmit side, the controller 28 communicates with an encoder 32 and also communicates with the HARQ buffer 30. The encoder 32 is coupled to a symbol modulator 34 that also handles sub-carrier mapping. The symbol modulator is coupled to an OFDM modulator 36 that, in turn, is coupled to an RF transmitter 38.

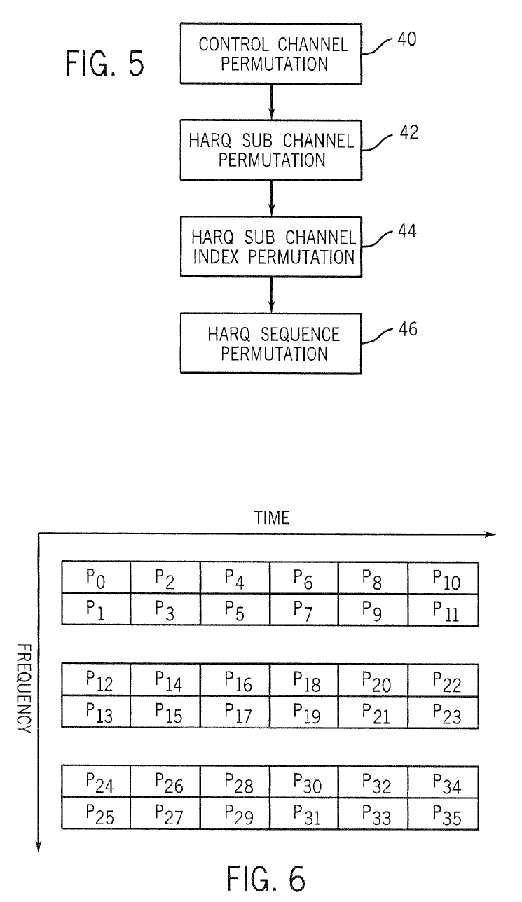

In accordance with some embodiments of the present invention, the cell interference is randomized in order to ensure robust performance in multi-cell operation scenarios as indicated in FIG. 5. Interference can be randomized on several levels. The first level (FIG. 5, block 40) may be in the HARQ region permutation, in which the tiles of different sectors may be permuted to different physical frequency-time locations. The permutation is cell specific and can hop with time to avoid constant collisions.

Since the time division (TDM)/frequency division (FDM) multiplexing or time division/frequency division/code division (CDM) multiplexing method is applied to the uplink HARQ feedback region, the second level may be inside the uplink HARQ feedback region (FIG. 5, block 42). This may include varying the HARQ acknowledge channel mapping, the HARQ acknowledge channel indexing (FIG. 5, block 44), and the HARQ acknowledge channel sequence (FIG. 5, block 46).

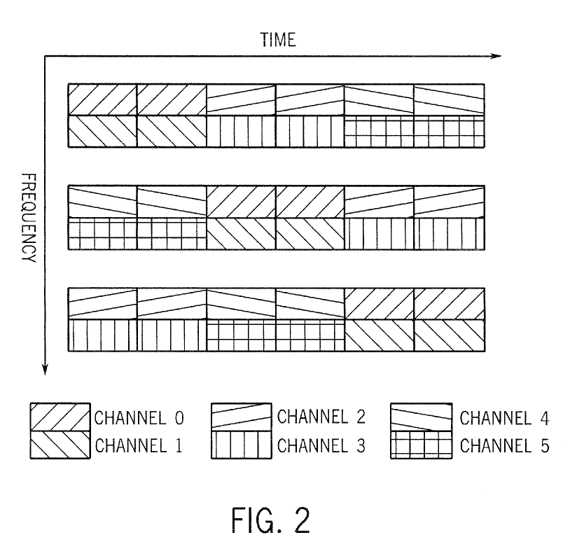

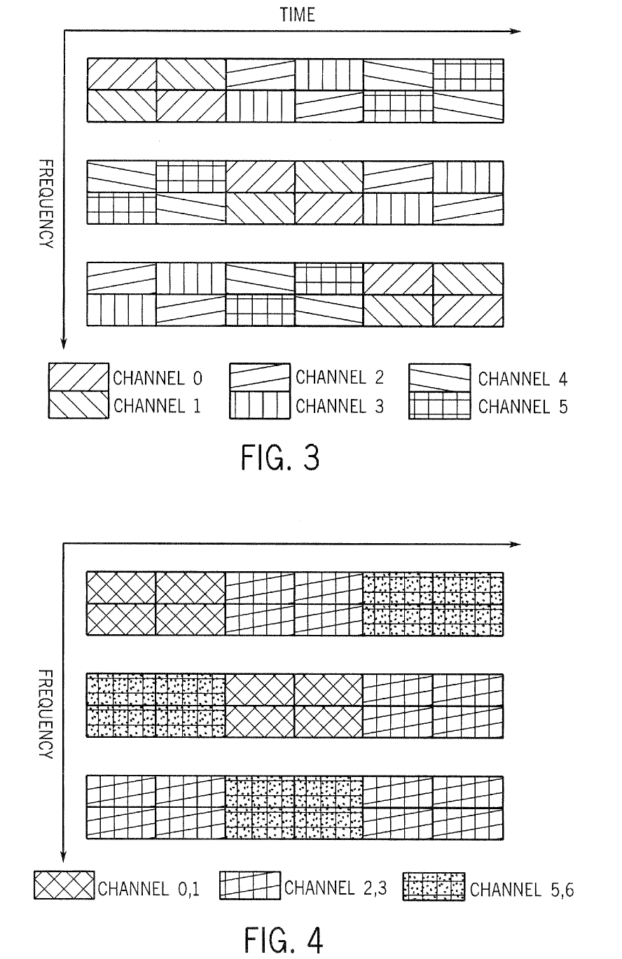

The control channel permutation (FIG. 5, block 40) may be accomplished as follows. As shown in FIGS. 2 and 3, each HARQ ACK channel includes three HARQ units. Each HARQ unit consists of one sub-carrier by two OFDM symbols. There exist two methods to map one HARQ unit to physical sub-carriers, as described in FIGS. 2 and 3.

The HARQ ACK channel permutation can be generalized as follows. Firstly, index the sub-carrier of one HARQ channel as FIG. 6. The 36 sub-carriers of one HARQ channel are indexed as Pᵢ,0≦i<36, where i is sub-carrier index. Pᵢ can be rewritten as P₁₂ₘ₊₂ₗ₊ₖ,0≦m<3,0≦l<6,0≦k<2, where m is the FMT index, l is OFDM symbol index and k is the sub-carrier index of one OFDM symbol of one 2×6 FMT.

The total 36 sub-carriers can be further divided into 18 units, each having 1 sub-carrier by 2 contiguous OFDM symbols. There are two types of units, as shown in FIGS. 2 and 3, respectively. The unit shown in FIG. 2 is denoted as Type 1 unit hereafter. The unit shown in FIG. 3 is denoted as Type 2 unit hereafter. For the two types of units, there are in total 36 unit positions. The position of one unit can be described by the positions of two sub-carriers. Qⱼ=(Qⱼ⁰,Qⱼ¹),0≦j<36, where j is unit index, Qⱼ^{s},0≦s<2 is the sub-carrier position of s^{th} sub-carrier of unit j. The first 18 units are Type 1 units and the sub-carrier positions can be written as equation (1):

$$\{ \begin{matrix}{Q}_{j}^{0} = {P}_{12 \cdot ⌊ j / 6 ⌋ + 4 \cdot ⌊ ( j mod 6 ) / 2 ⌋ + ( j mod 6 ) mod 2} \\ {Q}_{j}^{1} = {P}_{12 \cdot ⌊ j / 6 ⌋ + 2 \cdot ( 2 \cdot ⌊ ( j mod 6 ) / 2 ⌋ + 1 ) + ( j mod 6 ) mod 2}\end{matrix} \\ 0 \leq j < 18 \qquad ( 1 )$$

The remaining 18 units are for the Type 2 units and the sub-carrier positions can be written as equation 2 shown as below:

$$\{ \begin{matrix}{Q}_{j}^{0} = {P}_{12 \cdot ⌊ ( j - 18 ) / 6 ⌋ + 4 \cdot ⌊ ( ( j - 18 ) mod 6 ) / 2 ⌋ + ( ( j - 18 ) mod 6 ) mod 2} \\ {Q}_{j}^{1} = {P}_{12 \cdot ⌊ ( j - 18 ) / 6 ⌋ + 2 \cdot ( 2 \cdot ⌊ ( ( j - 18 ) mod 6 ) / 2 ⌋ + 1 ) + 1 - ( ( j - 18 ) mod 6 ) mod 2}\end{matrix} \\ 18 \leq j < 36 \qquad ( 2 )$$

The sub-carrier positions of 6 HARQ ACK channels can be described using 3 units Rₙ=(Qⱼ_{_{n,0}},Qⱼ_{_{n,1}},Qⱼ_{_{n,2}}),0≦n<6, where Qⱼ_{_{n,m}}ε{Qⱼ},0≦m<3,0≦j<36.

There are in total 64 positions for the 0^{th} HARQ ACK channel and it can be defined as below equation:

R₀ε{(Q_{{0,18}},Q_{{8,9,24,25}},Q_{{16,17,34,35}}),(Q_{{0,18}},Q_{{14,15,32,33}},Q_{{10,11,28,29}})} (3)

Denote the first half of R₀ as Ψ₀′={(Q_{{0,18}},Q_{{8 ,9,24,25}},Q_{{16,17,34,35}})} and the second half of R₀ as Ψ₀″={(Q_{{0,18}},Q_{{14,15,32,33}},Q_{{10,11,28,29}})}. The positions of the rest of the HARQ ACK channels depend on the positions of the first HARQ ACK channel:
If R₀εΨ₀′, the positions of the second and fourth HARQ ACK channels can be written as below two equations:

R₀εΨ₂′={(Q_{{6,24}},Q_{{14,15,30,31}},Q_{{4,5,22,23}})} (4)

R₄εΨ₄′={(Q_{{12,30}},Q_{{2,3,20,21}},Q_{{10,11,28,29}})} (5)
Otherwise, if R₀εΨ₀″, the positions of the second and fourth HARQ ACK channels can be written as below two equations:

R₂εΨ₂″={(Q_{{6,24}},Q_{{2,3,20,21}},Q_{{16,17,34,35}})} (6)

R₄εΨ₄″={(Q_{{12,30}},Q_{{8,9,26,27}},Q_{{4,5,22,23}})} (7)

The positions of the three odd HARQ ACK channels can be inferred from the positions of three even HARQ ACK channels:

R₂ᵤ₊₁=(Qⱼ_{_{2u−1,0}},Qⱼ_{_{2u+1,l}},Qⱼ_{_{2u+1.2}}),0≦u<3 (8)

where j_{2u+1,m}=└j_{2u,m}/2┘×4+1−j_{2u,m},0≦u<3,0≦m<3
So, in total for one type of unit, there are 65536 types of HARQ ACK channel permutation patterns in one HARQ ACK channel. One HARQ ACK channel permutation pattern can be uniquely represented by one index S where 0≦S<2¹⁶. S can be represented in binary as a₀, a₁, a₂, . . . , a₁₅. The first bit a₀ is subset selection bit.

If a₀=0

R₀εΨ₀′, R₂εΨ₂′, R₄εΨ₄′

Else

R₀εΨ₀″, R₂εΨ₂″, R₄εΨ₄″

End.

The following 5 bits a₁, a₂, . . . , a₅ can be used to describe the positions of HARQ ACK channel O. When the permutation pattern index a₁, a₂, . . . , a₅=‘00000’, the permutation pattern is selected by the first combination of Ψ₀′ or Ψ₀″, e.g. R₀=(Q₀,Q₈,Q₁₆) or R₀=(Q₀,Q₁₄,Q₁₀). If the permutation pattern index a₁, a₂, . . . , a₅=‘00001’, the permutation pattern is selected by the second combination of Ψ₀′ or Ψ₀″, e.g. R₀(Q₀,Q₈,Q₁₇) or R₀=(Q₀,Q₁₄,Q₁₁). Similarly, bits a₆, a₇, . . . , a₁₀ and a₁₁, a₁₂, . . . , a₁₅ are used to describe the positions of HARQ ACK channels 2 and 4 in a similar way, respectively.

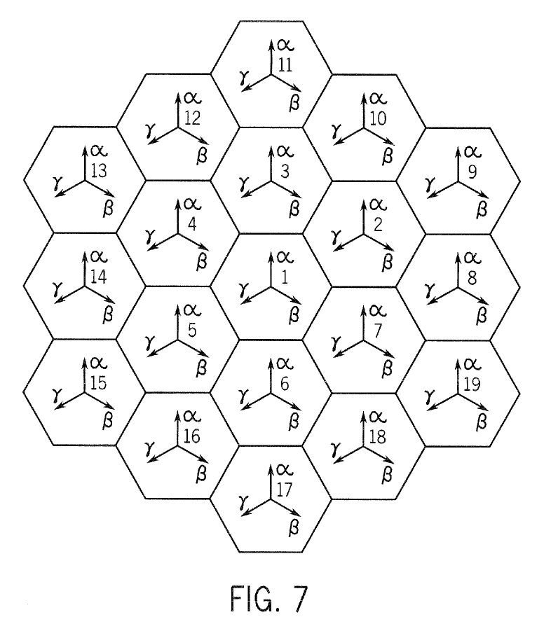

For a given section, S can change in time and the changing patterns for different sectors can be different to maximize interference randomization. One example of changing pattern of S is a pseudo random number with sector specific random number state. Or S can be planned among sectors. The planning of S can be done by planning the 16 bits of HARQ channel permutation pattern. One example of planning uses a network example, given in FIG. 7. The network is comprised of 19 cells with index c and a cell identifier (CID), where 1≦cid≦19. And each cell has three sectors α, β and γ. The sectors can be indexed globally as below:

$$\{ \begin{matrix}sid = ( cid - 1 ) \cdot 3 & α sector \\ sid = ( cid - 1 ) \cdot 3 + 1 & β sector \\ sid = ( cid - 1 ) \cdot 3 + 3 & γ sector\end{matrix} \qquad ( 9 )$$

a₀=sid mod 2

a₁, a₂, . . . , a₅ can be planned according to a table: [23 30 7 20 24 14 26 29 25 1 28 21 15 18 9 6 3 27 2 10 13 31 5 11 22 8 4 19 17 12 16 0] and the reuse distance is 32. For a given sector, a₁, a₂, . . . , a₅ should be the index sid mod 32 in above table.

a₆, a₇, . . . , a₁₀ and a₁₁, a₁₂, . . . a₁₅ can be planned accordingly.

For TDM/FDM/CDM method, there is one method to map one HARQ unit to physical sub-carriers as shown in FIG. 4. For the TDM/FDM/CDM method, the total 36 sub-carriers can be further divided into 9 units each having two sub-carriers by two continuous OFDM symbols. The position of one unit can be described by positions of four sub-carriers.

Qⱼ=(Qⱼ⁰, Qⱼ¹, Qⱼ², Qⱼ³),0≦j<9 where j is unit index, Qⱼ^{s},0≦s<4 is sub-carrier position of s^{th} sub-carrier of unit j. There is only one type of unit, as shown in FIG. 4. The sub-carrier position of TDM/FDM/CDM unit can be written as equation (10) shown as below:

Qⱼ^{s}=P_{12└ji3┘+4·(j mod 3)+s},0≦j<9,0≦s<4 (10)

There are in total two unit indexes for the first two HARQ ACK channel and it can be defined as below equation:

R₀=R₁ε{(Q₀,Q₄,Q₈),(Q₀,Q₇,Q₅)} (11)

If R₀=(Q₀, Q₄,Q₈), the positions of the rest of the four HARQ ACK channels can be described as below two equations:

R₂=R₃=(Q₃,Q₇,Q₂) (12)

R₂=R₃=(Q₆,Q₁,Q₅) (13)

If R₀=(Q₀, Q₇, Q₅), the positions of the rest of the four HARQ ACK channels can be described as below two equations:

R₂=R₃=(Q₃,Q₁,Q₈) (14)

R₄=R₅=(Q₆,Q₄,Q₂) (15)

So, in total for one type of unit, there are two types of HARQ ACK channel permutation patterns in one HARQ ACK channel. One bit is enough to describe the ACK channel permutation.

The HARQ sub-channel index permutation (FIG. 5, block 44) may be done as follows. When one mobile station is allocated one HARQ ACK channel, it will be allocated with a logical HARQ ACK channel index. We denote the logical ACK channel index as k, where k's range may be decided by a ACK logical index pool of a specific sub-frame. The mapping between the logical HARQ ACK channel index to a physical HARQ ACK channel index might change with time and the changing pattern is cell specific. For one ACK region, there are in total 720 channel index permutations. For each channel index permutation, the mapping from logical ACK channel index to physical ACK channel index is different. One example is each sector will change the permutation pattern according to a pseudo-random number between 0 and 719. And the random number state in each sector is different.

Alternatively, the channel index can be planned if there is enough information to perform inter sector coordination. Using the network example in FIG. 7, we can write the channel permutation as a function as below:

PhyChanId=(Log ChanId+sid*2)mod 6 (16)

This equation assumes, upon allocation of logical ACK channel index, each base station will allocate from lowest available logical ACK channel index or highest available logical ACK channel index. Then when load is low, inter-cell ACK interference can be orthogonal in time-frequency domain.

The HARQ sequence permutation (FIG. 5, block 46) is as follows. The sequence used to send ACK and NAK signal in a physical HARQ ACK channel can be defined as ACK as └1,e^{jθ}┘ and NAK as └1,−e^{jθ}┘, where θ can change with time and unit and the changing pattern is cell specific. One example is θε{0,π/4,π/2,3π/4,π,5π/4,3π/2,7π/4} and the phase index is a pseudo random number and the state is sector specific. Or it can be planned if there is enough information to perform inter sector coordination. Using the network example in FIG. 7, the phase index can be defined as below equation:

PhaseIdx=sid mod 8 (17)

In some embodiments, the sequence depicted in FIG. 5 may be implemented in firmware, software, or hardware. In a hardware implemented embodiment, it may be implemented by the HARQ unit 30 of FIG. 1. In a software implemented embodiment, it may be implemented by computer readable instructions executed by a computer, such as the controller 28 and stored in a suitable storage medium, such as a magnetic, optical, or semiconductor memory. That memory could be part of the HARQ unit 30 in FIG. 1 or the controller 28, as two examples.

In some embodiments, the radios depicted herein as the base station and the mobile station can include one or more than one antennae. In one embodiment, the mobile station and the base station may include one transmit antenna and two receive antennas.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using frequency hopping for a wireless communication;
randomizing inter cell interference for a hybrid automatic repeat request acknowledgement channel using frequency hopping; and
using time or frequency division multiplexing for said wireless communication.

2. The method of claim 1 including using frequency hopping in an acknowledgement channel also using code division multiplexing.

3. The method of claim 1 wherein using frequency hopping includes using control channel permutation.

4. The method of claim 3 further including using hybrid automatic repeat request sub-channel permutation.

5. The method of claim 4 further including using hybrid automatic repeat request sub-channel index permutation.

6. The method of claim 5 further including permuting tiles of different sectors to different physical frequency time locations.

7. The method of claim 1 including using a hybrid automatic repeat request channel that includes three hybrid automatic repeat request channel units, each unit including one sub-carrier with two orthogonal frequency division multiplexed symbols.

8. The method of claim 7 including mapping one hybrid automatic repeat request unit to physical sub-carriers.

9. The method of claim 1 including representing the hybrid automatic repeat request channel permutation patterns by one index S where zero is less than or equal to S and S is less than or equal to 2¹⁶.

10. The method of claim 9 including allowing S to change in time such that the change patterns for different sectors can be different to maximize interference randomization.

11. The method of claim 9 including planning S among sectors.

12. A computer readable medium storing instructions to enable a computer to:
use frequency hopping for wireless communication;
randomize inter cell interference for a hybrid automatic repeat request acknowledgement channel using frequency hopping; and
use time or frequency division multiplexing for said wireless communication.

13. The medium of claim 12 further storing instructions to use frequency hopping in an acknowledgement channel also using code division multiplexing.

14. The medium of claim 12 further storing instructions to use control channel permutation.

15. The medium of claim 14 further storing instructions to use hybrid automatic repeat request sub-channel permutation.

16. The medium of claim 15 further storing instructions to use hybrid automatic repeat request sub-channel index permutation.

17. The medium of claim 16 further storing instructions to permute tiles of different sectors and different physical frequency-time locations.

18. The medium of claim 12 further storing instructions to use a hybrid automatic repeat request channel that includes three hybrid automatic repeat request channel units, each unit including one sub-carrier with two orthogonal frequency division multiplexed symbols.

19. The medium of claim 18 further storing instructions to map one hybrid automatic repeat request unit to physical sub-carriers.

20. A mobile station comprising:
a unit to use frequency hopping to randomize inter cell interference for a hybrid automatic repeat request acknowledgement channel using time or frequency division multiplexing;
a receiver coupled to said unit; and
a transmitter coupled to said unit.

21. The mobile station of claim 20 wherein said unit is a hybrid automatic repeat request acknowledgement buffer.

22. The mobile station of claim 20 wherein said unit is a controller.

23. The mobile station of claim 21 including a hybrid automatic repeat request buffer coupled to a symbol modulator and an encoder on a radio frequency transmit side and a symbol demodulator and an error checker in a radio frequency receive side.

24. The mobile station of claim 20 wherein said mobile station uses code division multiplexing.

25. The mobile station of claim 20, said unit to use frequency hopping with control channel permutation.

26. The mobile station of claim 25, said unit to use hybrid automatic repeat request sub-channel permutation.

27. The mobile station of claim 26, said unit to use hybrid automatic repeat request sub-channel index permutation.

28. The mobile station of claim 27, said unit to permute tiles of different sectors to different physical frequency-time location.

29. The mobile station of claim 20, said unit to use a hybrid automatic repeat request channel that includes three hybrid automatic repeat request channel units, each unit including one sub-carrier with two orthogonal frequency division multiplexed signals.

30. The mobile station of claim 29, said unit to map one hybrid automatic repeat request unit to a physical sub-carrier.
